(19) United States
(12) Patent Application Publication
(10) Pub. No.: US 2011/0088844 A1
(43) Pub. Date: Apr. 21, 2011

(54) THERMALLY ACTIVATED ADHESIVE AND FIXTURE FOR IMPROVING REGISTRATION ACCURACY BETWEEN ASSEMBLED PARTS

(75) Inventor: Cameron Frazier, San Carlos, CA (US)

(73) Assignee: Apple Inc., Cupertino, CA (US)

(21) Appl. No.: 12/710,058

(22) Filed: Feb. 22, 2010

Related U.S. Application Data
(60) Provisional application No. 61/252,334, filed on Oct. 16, 2009.

(51) Int. Cl. B29C 65/52; B29C 65/02

(52) U.S. Cl. 156/325; 156/498

(57) ABSTRACT

This is directed to a method for assembling components using a thermally activated adhesive. Two components of an electronic device housing can be coupled as part of the electronic device assembly. At least one of the two components can be thermally conductive. To use a thermally conductive adhesive to couple the components, the components can be placed in a fixture, and the adhesive between the components. The fixture can then be heated such that heat from the fixture is conducted through the thermally conductive component and into the adhesive. The adhesive can flow and propagate between the components. When the adhesive layer has flowed into an adequate layer, the fixture can be cooled such that heat can be removed from the adhesive through the thermally conductive component. The adhesive can harden and secure the components to each other.

### BACKGROUND OF THE INVENTION

This is directed to a method and fixture for assembling at least one thermally conductive component to another component using a thermally activated adhesive. In particular, this is directed to a thermally activated adhesive having integrated pockets into which the adhesive can flow.

An electronic device enclosure can include several components that are assembled to each other. In some embodiments, a thermally conductive material (e.g., a metal) can be coupled to a thermally isolating material (e.g., a plastic). For example, an electronic device housing can include a housing constructed from plastic. The housing can be coupled to a frame via a series of metal hooks coupled to the housing. The metal hooks can be coupled to the housing any suitable approach. In some embodiments, a heat staking process can be used. Alternatively, a liquid adhesive can be used. As still another example, a mechanical fastener (e.g., screws) can be used.

These approaches, however, may require significant space between the plastic and metal components (e.g., with screws). Alternatively, the spacing between the plastic and metal components may be difficult to control, and the manufacturing process can include significant tolerances in the assembly of the plastic and metal components.

### SUMMARY OF THE INVENTION

This is directed to a method and process for coupling housing components using a thermally activated adhesive. In particular, this is directed to distributing a layer of a thermally activated adhesive between housing components and placing the components within a fixture.

Some device housing components can be coupled to each other using an adhesive. To more particularly control the height between the housing components upon assembly, the components can be coupled using a thermally activated adhesive. In one implementation, a thermally activated adhesive can be applied to a thermally or a non-thermally conductive material such as a die cut sheet of material, or as a silk screen. The applied adhesive can be substantially solid, but have limited adhesive strength prior to being heated. When the adhesive is heated, the adhesive can flow and adhere to the housing components. Upon subsequent cooling, the adhesive can remain adhered to both components over a large surface area (e.g., due to the flowing of the adhesive).

The thermally activated adhesive can be heated using any suitable approach. In some embodiments, the thermally activated adhesive can be placed between the enclosure or housing components, and the components placed in a fixture. The fixture can be heated such that the heat is conducted in the fixture, through a thermally conductive enclosure component (e.g., a thermally conductive housing component), and towards the adhesive. The adhesive can then flow between the components and adhere to the components. Once the adhesive has sufficiently flowed, the fixture can be cooled (e.g., via forced air or a cooling liquid).

To ensure that the thermally activated adhesive properly flows between the housing components, the adhesive can be applied in any suitable pattern or distribution. For example, the thermally activated adhesive can include several empty pockets within the adhesive layer into which the adhesive can flow when heated. As another example, the adhesive can be applied in a grid pattern.

The adhesive can have any suitable thickness. In some embodiments, the thickness of the adhesive layer, and as a result the height of the stack that includes the two components being coupled and the adhesive, can be accurately defined using the fixture. In particular, the fixture can bring the components together to a desired height (e.g., as defined by a hard stop of the fixture). By heating and quickly cooling the adhesive when the desired stack height has been reached, the fixture can define a repeatable stack height with high tolerances. The solid state of the adhesive prior to heating, combined with the internal pockets for assisting adhesive flow can ensure that the interface between the components remains smooth.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of assembled electronic device components in accordance with one embodiment of the invention;

FIG. 2 is a cross-sectional view of illustrative electronic device components assembled in a fixture in accordance with one embodiment of the invention;

FIG. 3 is a schematic view of an illustrative thermally activated adhesive sheet in accordance with one embodiment of the invention; and

FIG. 4 is a flow chart of an illustrative process for coupling two components in accordance with one embodiment of the invention.

### DETAILED DESCRIPTION

An electronic device can be assembled by coupling different types of components. For example, a housing component can be coupled to circuitry or electronics providing features of the device. As another example, an assembly component can be coupled to a housing element (e.g., couple a hook to a housing component). The different components can be coupled in many different manners. If at least one of the components is thermally conductive, however, a thermally activated adhesive can be used. The thermally activated adhesive is substantially solid when cool, but flows and adheres when heated.

By placing the components with the thermally activated adhesive in a fixture, the adhesive can be heated and directed to flow between the components to ensure an adequate bond. In particular, heat can be applied or removed through one of the fixtures and through the thermally conductive component to activate or deactivate the adhesive. The fixture can include stops or other elements to ensure that the components are assembled at a particular predetermined distance from one another. Because the thermally conductive adhesive can include pockets into which the adhesive can flow, the fixture can ensure a smooth and uniform bond of a desired height between the components.

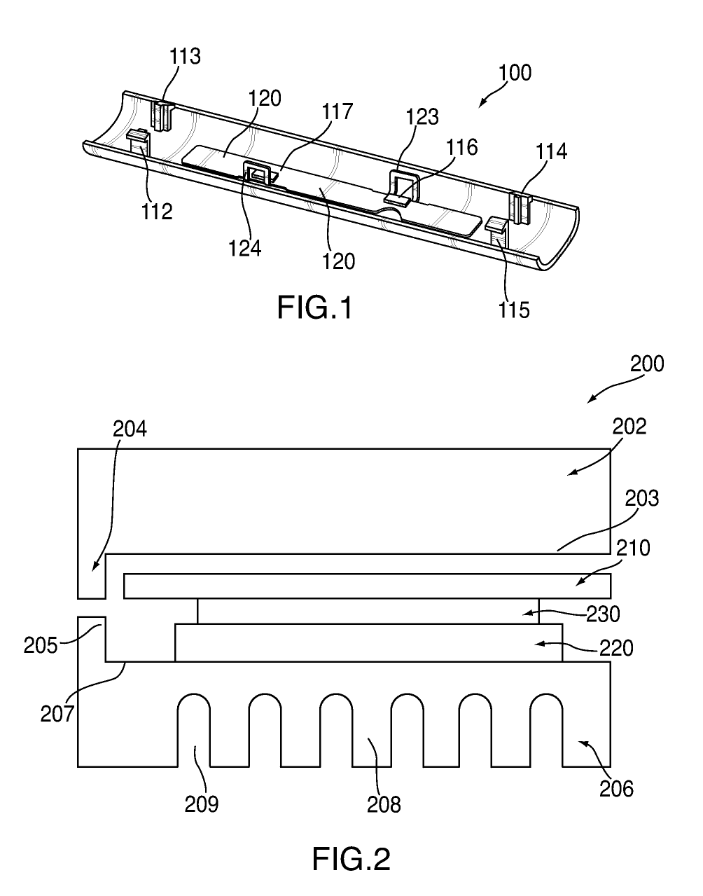

FIG. 1 is a schematic view of assembled electronic device components in accordance with one embodiment of the invention. Electronic device 100 can include housing 110 to which frame 120 is mounted. Housing 110 can include any suitable feature, including for example hooks 112, 113, 114 and 115. In some embodiments, housing 110 can include nubs 116 and 117 for coupling frame 120 to housing 110 using heat staking. Housing 110 can be constructed from any suitable material and using any suitable process. For example, housing 110 can be constructed via injection molding from a plastic. In some embodiments, housing 110 can be constructed from a thermally isolating material.

Frame 120 can include one or more features for coupling housing 110 to other elements of the electronic device. For example, frame 120 can include loops 122 and 123 that can be engaged by corresponding hooks from another device component (e.g., a circuit board support component). Frame 120 can be constructed from any suitable material, including for example a metal (e.g., to provide grounding for electrical components of the device). In some embodiments, the material selected for frame 120 can also be thermally conductive.

Frame 120 can be coupled to housing 110 using any suitable approach. In some embodiments, heat staking (e.g., using nubs 116 and 117 passing through openings of frame 120) can be used. Alternatively, a mechanical fastener or adhesive can be used (e.g., a liquid adhesive). These approaches, however, may limit the precision with which frame 120 can be placed over housing 110, and in particular can limit the precision in the total height between the housing and frame. Furthermore, heat staking and mechanical fasteners can introduce additional components or elements that pass through frame 120 or housing 110 and increase the height required for assembling the frame and housing.

As an alternative, a thermally activated adhesive can be used to couple the frame to the housing. A thermally activated adhesive can be used for coupling any suitable set of components, so long as at least one of the components is thermally conductive. For example, a thermally activated adhesive could be used to couple a circuit board to another component, provided the circuit board has sufficient copper or other elements to be adequately thermally conductive.

Because the thermally activated adhesive may need to be heated (e.g., at substantial temperatures) before flowing and adhering, the adhesive may need to be heated within a fixture. FIG. 2 is a cross-sectional view of illustrative electronic device components assembled in a fixture in accordance with one embodiment of the invention. Fixture 200 can include upper fixture 202 and lower fixture 206 (e.g., distinct fixture elements). Upper fixture 202 can include receiving surface 203 for receiving and supporting an electronic device component, such as component 210. Surface 203 can include any suitable feature, including for example a smooth surface or a surface matching the exterior surface of component 210. In some embodiments, surface 203 can include one or more aligning features for ensuring that component 210 is properly mounted in fixture 202. In some embodiments, surface 203 can include one or more features for helping release component 210.

Component 210 can include any suitable electronic device component, including for example a plastic component (or any other thermally isolating material). In one implementation, component 210 can include a housing from an electronic device. Component 210 can be coupled to component 220 using thermally activated adhesive 230. Component 220 can be supported by receiving surface 207 of lower fixture 206. Receiving surface 207 can include some or all of the features receiving surface 203, described above. Component 220 can include any suitable component of the electronic device to be coupled with component 210. In some embodiments, component 220 can include at least one thermally conductive element such that heat can be transferred by conduction between fixture 206 and adhesive 230. For example, component 220 can be constructed from a metal, such as aluminum, steel or a metal alloy. As another example, component 220 can be constructed from a composite material.

Adhesive 230 can be placed between components 210 and 220 using any suitable approach. In some embodiments, adhesive 230 can be initially coupled to one of the two components. For example, the adhesive can be provided as a die cut sheet of material placed between the components. As another example, the die cut sheet of material can be initially coupled to one of the components (e.g., component 210, which is not thermally conductive). In some embodiments, the adhesive can instead or in addition be placed on one of the components via a screen or deposition process. For example the adhesive can be laid on component 210 using a silk screening process. Adhesive 230 can have any suitable thickness, including for example a thickness that exceeds the desired final thickness of the adhesive layer when components 210 and 220 are coupled. This can ensure, for example, that the adhesive can flow and provide a uniform and complete layer between the components (e.g., a layer that does not include holes or variations in adhesive thickness).

Because adhesive 230 is a thermally activated adhesive, heat must be provided to the adhesive to cause it to flow and adhere to both components 210 and 220. Fixture 206 can include heat conductors 208, which may be operative to generate heat or receive heat from a heat source. For example, heat conductors 208 can be coupled to a resistor array or include resistance elements such that current can be applied to the resistor array or to heat conductor 208. As another example, heat conductors 208 can receive a heated fluid that passes through fixture 206. The heat generated or received by heat conductors 208 can propagate via conduction through fixture 206 to component 220. Because component 220 is thermally conductive, the heat can reach adhesive 230 and increase the temperature of adhesive 230. When the adhesive temperature reaches a critical point, the adhesive can flow in the gap between components 210 and 220. As the adhesive flows, fixtures 202 and 206 can be brought towards each other until hard stop 204 of fixture 202 contacts hard stop 205 of fixture 206. The hard stops can be adjustable so that the amount of adhesive 230 used, or the final height of adhesive layer 230 can be tuned.

Once hard stop 204 contacts hard stop 205, the fixture can be cooled so that adhesive 230 hardens while in contact with both components 210 and 220. As fixture 206 is cooled, heat can be extracted from adhesive 230, through component 220 and out of fixture 206. For example, cool air can be blown at or in fixture 206 (e.g., within a heat sink or grooves 209 of the fixture) such that the fixture and component are cooled, and subsequently cool adhesive 230. The fixture can be rapidly cooled such that the thickness and distribution of the adhesive layer can be fixed as soon as hard stop 204 and 205 contact.

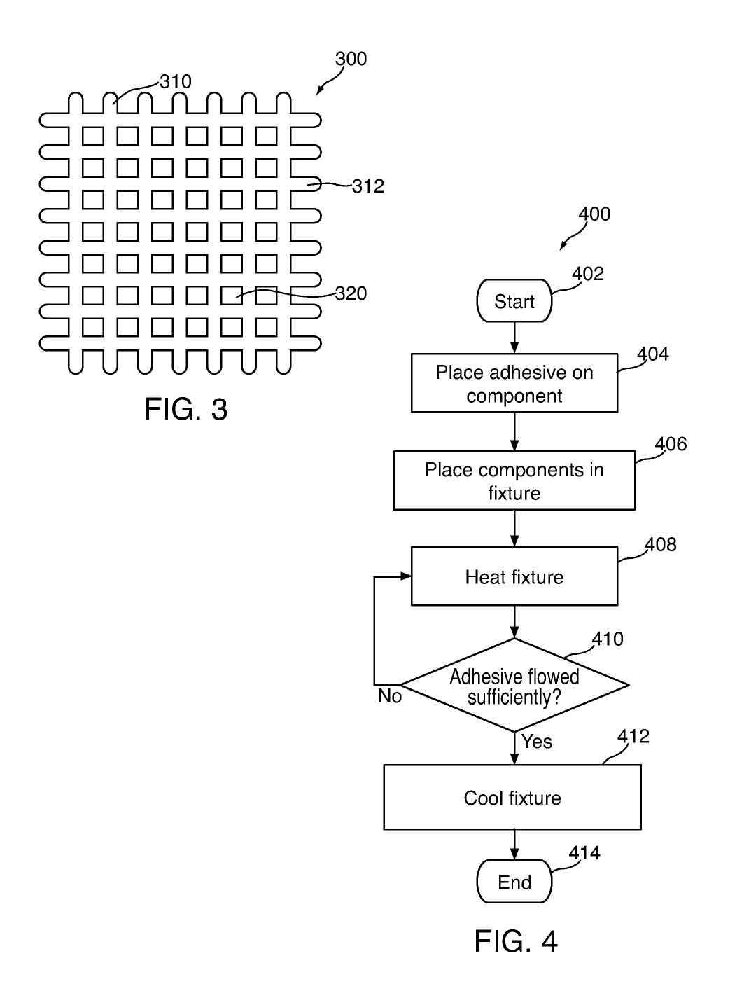

To ensure that the adhesive flows properly between components 210 and 220, the adhesive can include several integrated pockets into which the adhesive can flow when it is heated. FIG. 3 is a schematic view of an illustrative thermally activated adhesive sheet in accordance with one embodiment of the invention. Sheet 300 can include a sheet of adhesive placed between electronic device components. For example, sheet 300 can include a die cut sheet of material coupled to one of the components. As another example, sheet 300 can include a screened adhesive layer placed over the surface of one of the components. Sheet 300 can include several columns 310 and rows 312 of adhesive such that openings or pockets 320 having no adhesive are distributed within sheet 300. In particular, pockets 320 can be distributed such that the adhesive of columns 310 and rows 312 can flow into the pockets when the adhesive is heated, thus providing a large uniform adhesive surface in which adhesive did not need to travel long distances to provide the surface.

Sheet 300 can include any suitable number of pockets 320 distributed in any suitable pattern. In some embodiments, the size and distribution of the pockets can be selected based on the thickness of the adhesive sheet, the desired resulting adhesive layer (e.g., whether the adhesive layer should be uniform or include one or more holes), the shape of the adhesive layer (e.g., determined from the surface area available from each of the components, or any other suitable criteria. Although sheet 300 is shown to be a substantially orthogonal grid, it will be understood that sheet 300 can have any suitable shape and include any suitable number of pockets having any suitable shape. In particular, the size, shape and distribution of sheet 300 and of the pockets can be determined from the shape of the electronic device components that are connected using the adhesive.

FIG. 4 is a flow chart of an illustrative process for coupling two components in accordance with one embodiment of the invention. Process 400 can begin at step 402. At step 404, a thermally activated adhesive can be placed on a component. For example, a die cut layer of adhesive can be placed on the component. As another example, the adhesive can be applied to the component using a screening process. At step 406, the component and adhesive can be placed in a fixture with a second component, where the two components are to be coupled by the adhesive. At least one of the two components may be thermally conductive (e.g., constructed from metal). At step 408, the fixture can be heated. For example, current can be applied to the fixture to cause the fixture to heat. As another example, a heating element can be placed in contact with the fixture (e.g., adjacent to a fixture element). As the fixture heats, the heat may conduct to one of the components placed in the fixture. If the component is thermally conductive, the component can conduct heat received from the fixture to the adhesive layer. Because the adhesive is thermally activated, the adhesive may flow and propagate between the components. This approach, therefore, may be most efficient if the thermally conductive component is in contact with the fixture element being heated.

At step 410, it can be determined whether the adhesive has sufficiently flowed. For example, it can be determined whether the adhesive has flowed enough to cover a minimum surface area of the components. As another example, it can be determined whether hard stops of opposing fixture elements have come into contact, indicating that the adhesive layer has reached a desired height. If the adhesive has not yet flowed sufficiently, process 400 can return to step 408 and continue to heat the fixture. If, at step 410, the adhesive has instead sufficiently heated, process 400 can move to step 412. At step 412, the fixture can be cooled to fix the adhesive. In particular, as the fixture is cooled, heat can be extracted from the fixture elements, from the thermally conductive component placed in contact with the fixture elements, and from the adhesive in between the components. The fixture can be cooled using any suitable approach, including for example using forced air. Process 400 can then end at step 414.

The previously described embodiments are presented for purposes of illustration and not of limitation. It is understood that one or more features of an embodiment can be combined with one or more features of another embodiment to provide systems and/or methods without deviating from the spirit and scope of the invention. The present invention is limited only by the claims which follow.

What is claimed is:

1. A method for coupling a thermally conductive component to another component, comprising, comprising:
placing the thermally conductive component and the other component in a fixture, wherein the thermally conductive component is adjacent to a portion of the fixture that can be heated and cooled;
placing a thermally activated adhesive between the thermally conductive component and the other component;
heating the fixture such that the thermally activated adhesive receives heat conducted through the thermally conductive component; and
cooling the fixture to fix the adhesive.

2. The method of claim 1, further comprising:
approaching the thermally conductive component towards the other component until the fixture reaches a hard stop.

3. The method of claim 2, wherein:
placing further comprises:
placing the thermally conductive component in a first fixture element;
placing further comprises placing the other component in a second fixture element; and
approaching further comprises approaching the first and second fixture elements.

4. The method of claim 3, wherein:
the first fixture element comprises a first hard stop;
the second fixture element comprises a second hard stop; and
approaching further comprises approaching the first and second fixture elements until the first hard stop abuts the second hard stop.

5. The method of claim 4, further comprising:
adjusting the first and second hard stops to define a minimal distance between the thermally conductive component and the other component.

6. The method of claim 3, wherein heating further comprises:
heating the first fixture element.

7. The method of claim 6, wherein cooling further comprises:
cooling the first fixture element.

8. The method of claim 1, wherein placing further comprises:
placing the adhesive in a layer having an opening into which the adhesive can flow.

9. A fixture for securing components of an electronic device housing, comprising:
a first fixture element operative to receive a thermally conductive housing component, wherein the first fixture element comprises a first hard stop;
a second fixture element operative to receive another housing component, wherein the second fixture element comprises a second hard stop;
a heat source operative to heat the first fixture element; and
a cooling source operative to cool the first fixture element.

10. The fixture of claim 9, further comprising:
a mechanism for approaching the first fixture element to the second fixture element.

11. The fixture of claim 10, wherein:
at least one of the first and second hard stops is adjustable to define the minimum distance between the first and second fixture elements.

12. The fixture of claim 9, wherein the first fixture element further comprises:
a path for conducting heat through the first fixture element to the thermally conductive housing component.

13. The fixture of claim 9, further comprising:
a path for removing heat from the first fixture element to remove heat from the thermally conductive housing component.

14. A method for coupling a thermally conductive component to a second component, comprising:
placing a thermally conductive component in a first fixture;
placing a second component in a second fixture;
applying a thermally activated adhesive between the thermally conductive component and the second component;
heating the first fixture to conduct heat through the thermally conductive component to the thermally activated adhesive; and
approaching the first fixture to the second fixture to cause the thermally activated adhesive to flow between the thermally conductive component and the second component.

15. The method of claim 14, wherein applying further comprises:
defining a pattern in which to apply the thermally activated adhesive, wherein the pattern comprises at least one hole.

16. The method of claim 15, wherein applying further comprises:
applying the thermally activated adhesive in a grid pattern.

17. The method of claim 16, further comprising:
causing portions of the thermally activated adhesive to flow within the openings of the grid pattern.

18. The method of claim 14, further comprising:
cooling the first fixture to cause the thermally activated adhesive to adhere to both the thermally activated component and the second component.

19. The method of claim 18, wherein:
cooling further comprises transferring a cold fluid into the first fixture element.

20. The method of claim 14, wherein heating further comprises:
transferring heat to at least one heat conductor of the first fixture.
